(19) United States
(12) Patent Application Publication
(10) Pub. No.: US 2008/0065790 A1
(43) Pub. Date: Mar. 13, 2008

(54) Method for pairing hosts and I/O peripherals in centralized computer system

(75) Inventors: Chin Tsai Yen, Taipei City (TW); Chih Feng Mai, Banciao City (TW); Pi-Cheng Chen, Sinjhuang City (TW); Te Hsien Lai, Banciao City (TW)

Correspondence Address: THE LAW OFFICES OF ANDREW D. FORTNEY, PH.D., P.C., 401 W FALLBROOK AVE STE 204, FRESNO, CA, 93711-5835, US

(73) Assignee: Quanta Computer Inc.

(21) Appl. No.: 11/804,421

(22) Filed: May 17, 2007

(30) Foreign Application Priority Data
Sep. 8, 2006 (TW) 095133370

(51) Int. Cl. G06F 3/00

(52) U.S. Cl. 710/12

(57) ABSTRACT

The invention discloses a centralized computer system, i.e., so-called blade PC system. The centralized computer system according to the invention includes a plurality of centralized and bladed hosts and a plurality of I/O peripherals. In particularly, the centralized computer system according to the invention is capable of pairing the hosts and the I/O peripherals.

### BACKGROUND OF THE INVENTION

1. Field of the Invention

The invention relates to a centralized computer system, i.e., so-called blade PC system, and more particularly, to a centralized computer system capable of pairing the hosts and the I/O peripherals.

2. Description of the Prior Art

Many commercial businesses and enterprises make extensive use of personal computers (PCs) in their daily operations. Typically, each user of a PC in the enterprise has a networked PC at his/her desk or work area. As the number of networked computer systems utilized in an enterprise increases, the management of resources in the network may become increasingly complex and expensive. Referring to FIG. 1, FIG. 1 is a schematic diagram illustrating an infrastructure of a typical centralized computer system. As shown in FIG. 1, the centralized computer system 1 comprises a plurality of hosts 12 and a plurality of sets of I/O peripherals 14. Each set of I/O peripherals 14 comprises at least one peripheral device. The hosts 12 in the centralized computer system 1 are bladed, i.e., each host 12 is implemented into a “card”. In other words, each host 12 comprised on a circuit card comprises standard computer system components. The centralized computer system 1 also comprises a network 16 for the hosts 12 to communicate with the remote peripherals. The network 16 may be Local Area Network (LAN), such as intranet, or Wide Area Network (WAN), such as internet. As shown in FIG. 1, each set of I/O peripherals 14 comprises a display 142, a keyboard 144, a mouse 146, and/or other peripheral devices for human interface. Each host 12 in the centralized computer system 1 transmits and receives encoded I/O signals via the network 16 to communicate with each set of I/O peripherals 14.

In general, a large blade PCs (hosts), I/O peripherals, and end users are required in enterprises. Relatively, the following problems bring the service manager a heavy burden: (a) how to pair the I/O peripherals and the hosts; (b) how to pair the end users and the hosts; (c) the authority of the I/O peripherals relates to the hosts; and (d) the authority of the end users relates to the hosts.

Therefore, the scope of the invention is to provide a centralized computer system and the pairing method for pairing the hosts and the I/O peripherals.

### SUMMARY OF THE INVENTION

A scope of the invention is to provide a centralized computer system and the pairing method for pairing the hosts and the I/O peripherals by a hierarchical directory.

Another scope of the invention is to provide a centralized computer system and the pairing method for pairing the hosts and the end users by a hierarchical directory.

According to a preferred embodiment, the pairing method of the invention is applied to the centralized computer system. The centralized computer system comprises a network, at least one host, and at least one set of I/O peripherals. The pairing method is capable of selectively enabling one of the sets of I/O peripherals to operate one of the hosts via the network. According to the pairing method of the invention, first, a hierarchical directory is established. Afterward, in the hierarchical directory, a first connecting relation for each host and each set of I/O peripherals and a second connecting relation for each host and at least one end user are selectively defined.

If the first connecting relation exists between one of the hosts and one of the sets of I/O peripherals, the set of I/O peripherals can be used to operate the host via the network. If the second connecting relation exists between one of the hosts and one of the end users, the end user can use any set of I/O peripherals to operate the host via the network. If the second connecting relation is absent between one of the hosts and one of the end users, the end user can only use the set of I/O peripherals having the first connecting relation related to the host to operate the host via the network.

According to the centralized computer system and the pairing method of the invention, the service manager can use the hierarchical directory to define connecting relation for each host and each set of I/O peripherals and further define connecting relation for each host and each end user. Therefore, the invention not only can reduce the burden on the server manager but also can avoid wasting network management resource.

The advantage and spirit of the invention may be understood by the following recitations together with the appended drawings.

### BRIEF DESCRIPTION OF THE APPENDED DRAWINGS

FIG. 1 is a schematic diagram illustrating an infrastructure of a typical centralized computer system; and

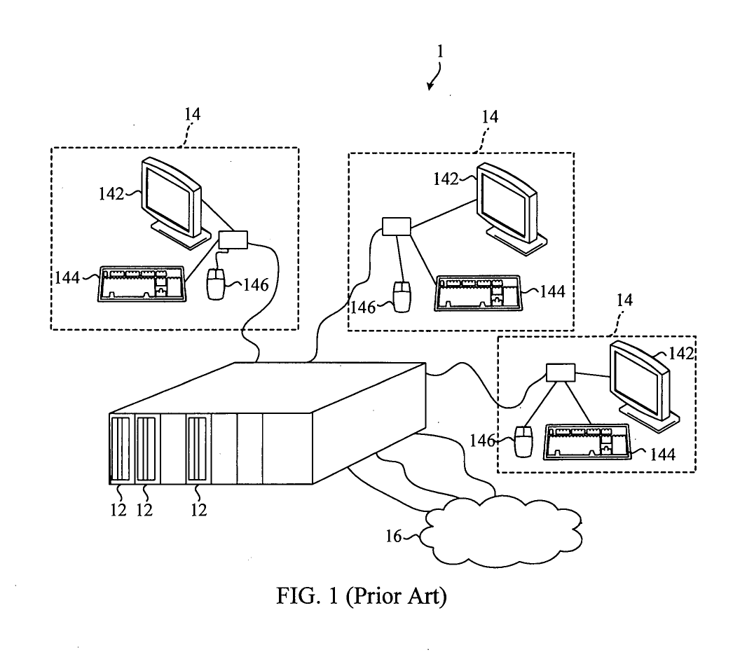

FIG. 2 is a schematic diagram illustrating an infrastructure of a centralized computer system according to a preferred embodiment of the invention.

### DETAILED DESCRIPTION OF THE INVENTION

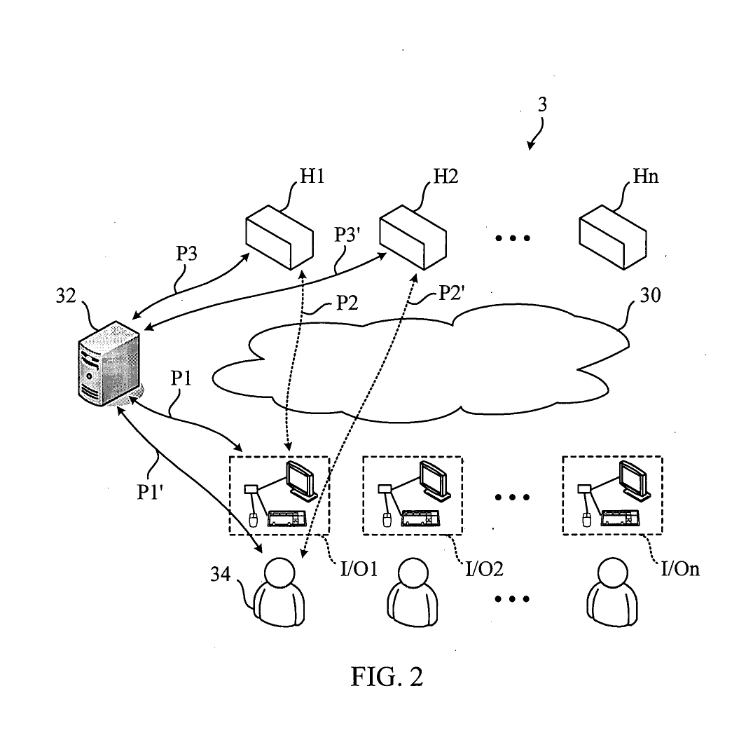

Referring to FIG. 2, FIG. 2 is a schematic diagram illustrating an infrastructure of a centralized computer system 3 according to a preferred embodiment of the invention. The centralized computer system 3 comprises a network 30, a plurality of hosts H1˜Hn, a plurality of I/O peripherals I/O1˜I/On, and a hierarchical server 32. In this embodiment, the hierarchical server 32 complies with but is not limited to a Lightweight Directory Access Protocol (LDAP). In this embodiment, each host H1˜Hn has a plurality of operating functions, wherein these operating functions comprise at least one selected from a group consisting of: console redirection, audio redirection, keyboard and mouse redirection, virtual storage redirection, monitoring and controlling, and other operating functions.

In the invention, a hierarchical directory is stored in the hierarchical service 32. The hierarchical directory is used for defining a first connecting relation for each host H1˜Hn and each set of I/O peripherals I/O1˜I/On and for defining a first authority for each set of I/O peripherals related to each host H1˜Hn. The first connecting relation comprises a first user name and a first password corresponding to the first user name. For example, if the first connecting relation exists between the host H1 and the set of I/O peripherals I/O1, the set of I/O peripherals I/O1 can be used to operate the host H1 via the network 30. The first user name and the first password are stored in the set of I/O peripherals I/O1 and cannot be modified. Additionally, the first authority allows the set of I/O peripherals I/O1 to operate at least one of the operating functions of the host H1 via the network 30.

Furthermore, as shown in FIG. 2, if an end user 34 wants to use the set of I/O peripherals I/O1 to operate the host H1, the set of I/O peripherals I/O1 can utilize the predetermined first user name and the predetermined first password to login the hierarchical server 32 (as the transmitting path P1 shown in FIG. 2). According to the first connecting relation defined in the hierarchical directory, the set of I/O peripherals I/O1 can connect with the host H1. Afterward, the set of I/O peripherals I/O1 transmits the first user name and the first password to the host H1 (as the transmitting path P2 shown in FIG. 2). Finally, the host H1 utilizes the first user name and the first password to login the hierarchical server 32 (as the transmitting path P3 shown in FIG. 2), so as to obtain the first authority. Whereby, according to the first authority, the set of I/O peripherals I/O1 can be used to operate at least one of the operating functions of the host H1 via the network 30. It should be noted that the service manager can define the first authority according to the capacity of each end user.

In this embodiment, the service manager can also selectively define the second connecting relation for each host H1˜Hn and at least one end user and selectively define a second authority for each end user related to each host H1˜Hn in the hierarchical directory. The second connecting relation comprises a second user name and a second password corresponding to the second user name. For example, if the second connecting relation exists between the host H2 and the end user 34, the end user 34 can use any set of I/O peripherals I/O1˜I/On to operate the host H2 via the network 30, even if the first connecting relation is absent between any set of I/O peripherals I/O1˜I/On and the host H2. In other words, due to the absence of the second connecting relation between the host H1 and the end user 34, the end user 34 can only use the set of I/O peripherals having the first connecting relation related to the host H1 to operate the host H1 via the network 30.

Moreover, as shown in FIG. 2, if the end user 34 wants to use the set of I/O peripherals I/O1 to operate the host H2, the end user 34 can use the set of I/O peripherals I/O1 to input the second user name and the second password to login the hierarchical server 32 (as the transmitting path P1′ shown in FIG. 2). According to the second connecting relation defined in the hierarchical directory, the connection between the set of I/O peripherals I/O1 and the host H2 is allowed. Afterward, the set of I/O peripherals I/O1 transmits the second user name and the second password to the host H2 (as the transmitting path P2′ shown in FIG. 2). Finally, the host H2 utilizes the second user name and the second password to login the hierarchical server 32 (as the transmitting path P3′ shown in FIG. 2), so as to obtain the second authority. Whereby, according to the second authority, the end user 34 can use the set of I/O peripherals I/O1 to operate at least one of the operating functions of the host H2 via the network 30. It should be noted that the service manager can define the second authority according to the capacity of each end user.

Compared to the prior art, according to the centralized computer system and the pairing method of the invention, the service manager utilizes the hierarchical directory to define the connecting relation for each host and each set of I/O peripherals and the connecting relation for each host and each end user. Additionally, the service manager can utilizes the hierarchical directory to define the authority for each set of I/O peripherals related to the host and the authority for each end user related to the host. Therefore, the invention not only can reduce the burden on the server manager but also can avoid wasting network management resource.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A pairing method for a centralized computer system, the centralized computer system comprising a network, at least one host, and at least one set of I/O peripherals, the pairing method being capable of selectively enabling one of the at least one set of I/O peripherals to operate one of the at least one host via the network, the pairing method comprising steps of:
establishing a hierarchical directory; and
in the hierarchical directory, selectively defining a first connecting relation for each host and each set of I/O peripherals,
wherein if the first connecting relation exists between one of the at least one host and one of the at least one set of I/O peripherals, the set of I/O peripherals is capable of operating the host via the network.

2. The pairing method of claim 1, wherein the hierarchical directory complies with a Lightweight Directory Access Protocol (LDAP).

3. The pairing method of claim 1, wherein the first connecting relation comprises a first user name and a first password corresponding to the first user name, and the set of I/O peripherals utilizes the first user name and the first password to operate the host via the network.

4. The pairing method of claim 1, wherein the host has a plurality of operating functions, the pairing method further comprising step of:
in the hierarchical directory, selectively defining a first authority for each set of the I/O peripherals related to each host,
whereby if the first connecting relation exists between one of the at least one host and one of the at least one set of I/O peripherals, according to the first authority, the set of I/O peripherals is capable of operating at least one of the operating functions of the host via the network.

5. The pairing method of claim 4, wherein the operating functions comprise at least one selected from a group consisting of: console redirection, audio redirection, keyboard and mouse redirection, virtual storage redirection, and monitoring and controlling.

6. The pairing method of claim 4, further comprising step of:
in the hierarchical directory, selectively defining a second connecting relation for each host and at least one end user,
wherein if the second connecting relation exists between one of the at least one host and one of the at least one end user, the end user is capable of utilizing any set of I/O peripherals to operate the host via the network; if the second connecting relation is absent between one of the at least one host and one of the at least one end user, the end user is only capable of utilizing the set of I/O peripherals having the first connecting relation with the host to operate the host via the network.

7. The pairing method of claim 6, wherein the second connecting relation comprises a second user name and a second password corresponding to the second user name, and the end user utilizes the second user name and the second password to operate the host via the network.

8. The pairing method of claim 6, further comprising step of:
in the hierarchical directory, selectively defining a second authority for each end user related to each host,
whereby if the second connecting relation exists between one of the at least one host and one of the at least one end user, according to the second authority, the end user is capable of utilizing any set of I/O peripherals to operate at least one of the operating functions of the host via the network; if the second connecting relation is absent between one of the at least one host and one of the at least one end user, according to the second authority, the end user is capable of utilizing the set of I/O peripherals having the first connecting relation with the host to operate at least one of the operating functions of the host via the network.

9. A centralized computer system, comprising:
a network;
at least one host;
at least one set of I/O peripherals; and
a hierarchical server for storing a hierarchical directory, the hierarchical directory selectively defining a first connecting relation for each host and each set of I/O peripherals,
wherein if the first connecting relation exists between one of the at least one host and one of the at least one set of I/O peripherals, the set of I/O peripherals is capable of operating the host via the network.

10. The centralized computer system of claim 9, wherein the hierarchical server complies with a LDAP.

11. The centralized computer system of claim 9, wherein the first connecting relation comprises a first user name and a first password corresponding to the first user name, and the set of I/O peripherals utilizes the first user name and the first password to operate the host via the network.

12. The centralized computer system of claim 9, wherein the host has a plurality of operating functions, and the hierarchical directory further selectively defines a first authority for each set of I/O peripherals related to each host, whereby if the first connecting relation exists between one of the at least one host and one of the at least one set of I/O peripherals, according to the first authority, the set of I/O peripherals is capable of operating at least one of the operating functions of the host via the network.

13. The centralized computer system of claim 12, wherein the operating functions comprise at least one selected from a group consisting of: console redirection, audio redirection, keyboard and mouse redirection, virtual storage redirection, and monitoring and controlling.

14. The centralized computer system of claim 12, wherein the hierarchical directory further selectively defines a second connecting relation for each host and at least one end user, whereby if the second connecting relation exists between one of the at least one host and one of the at least one end user, the end user is capable of utilizing any set of I/O peripherals to operate the host via the network; if the second connecting relation is absent between one of the at least one host and one of the at least one end user, the end user is only capable of utilizing the set of I/O peripherals having the first connecting relation with the host to operate the host via the network.

15. The centralized computer system of claim 14, wherein the second connecting relation comprises a second user name and a second password corresponding to the second user name, and the end user utilizes the second user name and the second password to operate the host via the network.

16. The centralized computer system of claim 14, wherein the hierarchical directory further selectively defines a second authority for each end user related to each host, whereby if the second connecting relation exists between one of the at least one host and one of the at least one end user, according to the second authority, the end user is capable of utilizing any set of I/O peripherals to operate at least one of the operating functions of the host via the network; if the second connecting relation is absent between one of the at least one host and one of the at least one end user, according to the second authority, the end user is capable of utilizing the set of I/O peripherals having the first connecting relation with the host to operate at least one of the operating functions of the host via the network.
